(19) United States
(12) Patent Application Publication
(10) Pub. No.: US 2007/0058229 A1
(43) Pub. Date: Mar. 15, 2007

(54) Volumetric Three-Dimensional Display System

(76) Inventors: Russell Hudyma, San Ramon, CA (US); Michael Thomas, Belmont, MA (US); Paul Rose, Nashua, MA (US); Rick K. Dorval, Goffstown, NH (US)

Correspondence Address: FISH & RICHARDSON PC, P.O. BOX 1022, MINNEAPOLIS, MN, 55440-1022, US

(21) Appl. No.: 11/470,397

(22) Filed: Sep. 6, 2006

Related U.S. Application Data
(60) Provisional application No. 60/718,156, filed on Sep. 15, 2005.

(51) Int. Cl. G02B 26/08

(52) U.S. Cl. 359/196

(57) ABSTRACT

The invention features a volumetric display system. A light beam representing an image is provided from a stationary source. A projection screen is rotated, relative to the stationary source, about a rotation axis. The light beam is projected onto the projection screen at a non-normal angle of incidence. The light beam is manipulated to reduce distortion in the image caused by projection of the light beam onto the projection screen.

### CROSS-REFERENCE TO RELATED APPLICATIONS

This application claims priority to U.S. Provisional Application Ser. No. 60/718,156, filed on Sep. 15, 2005, incorporated herein by reference.

### TECHNICAL FIELD

This invention relates to three-dimensional displays, and more particularly to volumetric three-dimensional displays.

### BACKGROUND

There are many types of three-dimensional displays, including stereoscopic displays, multiplanar volumetric displays, holographic video systems, and multi-view three-dimensional displays. Applications of three-dimensional displays include the depiction of medical images, such as a transparent CT image of a patient's anatomy which includes vasculature and tumors; geophysical data for the petroleum industry, such as seismic data overlaid with drill paths; three-dimensional luggage scan data, such as a CT scan of luggage in which each three-dimensional pixel (“voxel”) is color coded as a function of effective atomic number; the depiction of complex three-dimensional computer-aided design (CAD) models; and entertainment systems, such as video gaming systems and casino gaming systems.

Volumetric displays are a class of three-dimensional display technology that produce volume-filling imagery. Typically, volumetric displays are autostereoscopic; that is, they produce imagery that appears three-dimensional without the use of additional eyewear.

Some volumetric displays create three-dimensional imagery by employing spatio-temporal multiplexing in emitting or scattering light from a range of locations within an image volume. In other words, a smaller number of light-generating devices (for example, lasers, projector pixels, etc.) are run at a higher frequency than an overall volumetric refresh rate, and the light is imaged onto a rotating surface. Persistence of vision temporally integrates the image slices formed at different spatial locations of the volume swept by the rotating surface, and the viewer perceives a volume-filling, three-dimensional image.

### SUMMARY

The invention features systems and methods for producing three-dimensional volume-filling imagery. A volumetric display system produces a volume image by projecting a series of two-dimensional images onto a rapidly rotating projection screen. Persistence of the human visual system integrates these two-dimensional image slices into a three-dimensional volume-filling image.

In general, in one aspect, the invention features a volumetric display system including a first optical assembly configured to provide a light beam representing an image, the first optical assembly being disposed on a first support structure;

a motor coupled to the first support structure and configured to rotate a second support structure, relative to the first support structure, about a rotation axis; and

a second optical assembly that includes one or more optical elements configured to manipulate the light beam to reduce distortion in the image caused by projection of the light beam onto a projection screen at a non-normal angle of incidence, the second optical assembly being disposed on the second support structure.

In general, in another aspect, the invention features a method, including providing a light beam representing an image from a stationary source; rotating a projection screen, relative to the stationary source, about a rotation axis; projecting the light beam onto the projection screen at a non-normal angle of incidence; and manipulating the light beam to reduce distortion in the image caused by projection of the light beam onto the projection screen.

Aspects of the invention may include any of the following features.

The system further includes an image data and illumination module configured to provide an unmodulated light beam and image data defining the image, wherein the first optical assembly is configured to generate the light beam by spatially modulating the unmodulated light beam according to the image data.

The system further includes a projection screen disposed on the second support structure and positioned to receive a manipulated light beam from the second optical assembly, the projection screen having a substantially flat surface that is substantially parallel to the rotation axis.

The second optical assembly includes a mirror disposed along the rotation axis to receive the light beam from the second optical assembly.

The first optical assembly is configured to image the spatially modulated light beam to an intermediate image plane, where the intermediate image plane is substantially perpendicular to the rotation axis and less than about two centimeters from the mirror.

The first optical assembly is further configured to: split the unmodulated light beam received from the image data and illumination module into a plurality of component beams of different color; modulate each component beam according to corresponding image data; and recombine the modulated component beams into in a combined light beam representing a multi-color image.

The first optical assembly includes a plurality of optical elements arranged to support forward light paths from locations at which the component beams are modulated to a mirror and reverse light paths from the mirror to an output of the first optical assembly, where the forward light paths are arranged with respect to the reverse light paths to enable the reverse path to at least partially compensate for aberrations produced by the forward path.

The reverse path is arranged to substantially compensate for spherical aberration produced by the forward path.

The reverse path is arranged to reduce spherical aberration produced by the forward path to less than one wavelength.

The first optical assembly includes at least one optical element configured to reduce chromatic aberration induced by other optical elements of the first optical assembly.

The second optical assembly is configured to manipulate the light beam to reduce one or more of keystone distortion, pincushion distortion, and barrel distortion.

The second optical assembly is configured to manipulate the light beam to compress the transverse profile of the light beam along a first transverse direction relative to a second perpendicular transverse direction.

The amount of relative compression is based on an angle at which the image is to be projected onto the projection screen.

The second optical assembly is configured to provide a tilted focal plane according to the angle at which the image is projected onto the projection screen.

The second optical assembly is configured to manipulate the light beam to provide a large depth of focus at the projection screen.

The depth of focus is larger than the size of the projected image multiplied by the sine of the angle of incidence at the projection screen.

The second optical assembly is further configured to manipulate the light beam to substantially flatten the field of the image represented by the light beam.

The second optical assembly consists essentially of reflective optical elements including at least one curved mirror.

The second optical assembly includes at least one mirror having a negative curvature characterized by a concave curvature along a first cross-section and a convex curvature along an orthogonal cross-section.

The second optical assembly includes one mirror having a negative curvature, at least one mirror having a positive convex curvature, and at least one mirror having a positive concave curvature.

The second optical assembly is configured to magnify the image when projected onto a projection screen, relative to the size of the image when spatially modulated onto the light beam by the first optical assembly.

The magnification is at least a factor of 10.

The image data and illumination module is configured to process the image data to reduce residual distortion not corrected by the one or more optical elements of the second optical assembly.

The second optical assembly is configured to reduce distortion in the image such that the size of any residual distortion is less than about 5% of the size of the image.

The second optical assembly is configured to reduce distortion in the image such that any point in the projected image is displaced from its respective location in the image provided by the first optical assembly to less than 5% relative to the size of the projected image.

The image data and illumination module is configured to process the image data to reduce distortion in the image such that the size of any residual distortion not corrected by the combined effect of the processing and the one or more optical elements of the second optical assembly is less than 2% of the size of the image.

The image data and illumination module is configured to process the image data to reduce distortion in the image such that the size of any residual distortion not corrected by the combined effect of the processing and the one or more optical elements of the second optical assembly is less than the size of two pixels of the image.

The first optical assembly and the second optical assembly include one or more adjustable components to project the image onto the projection screen in-focus and approximately centered on the projection screen.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of a volumetric display.

FIG. 2A is a diagram of a front-end optical assembly.

FIGS. 2B and 2C are front and side views of a prism assembly.

FIGS. 3A-3C are diagrams showing unfolded forward and reverse paths through the front-end optical assembly.

FIG. 4 is a diagram of a back-end optical assembly.

FIG. 5A and 5B are perspective views of portions of the volumetric display.

Like reference symbols in the various drawings indicate like elements.

### DETAILED DESCRIPTION

A three-dimensional volumetric display includes a projection system that has a front-end that provides an image, and a back-end that delivers the relayed image to one or more viewers. The front-end is stationary, mounted below the viewing volume and out of sight from the viewer. A data and illumination module receives image data from a computer or other source of image data, and enables the front-end to generate an image using, for example, a Digital Light Processing (DLPTM is a trademark of Texas Instruments) display, a liquid crystal display (LCD), or a liquid crystal on silicon (LCOS) display. The computer can also provide a user interface. The front-end includes optical components that provide an optical path arrangement to mitigate certain optical aberrations in a compact space. The back-end is mounted on, or coupled to, a portion of the volumetric display that rotates during operation. The back-end delivers the image supplied by the front-end to a screen which rotates with the back-end during operation. The back-end includes optical components that reduce distortion in the image projected onto the screen. For example, in some embodiments the back-end includes an optical assembly that is able to optically compensate for most of the distortion in the projected image.

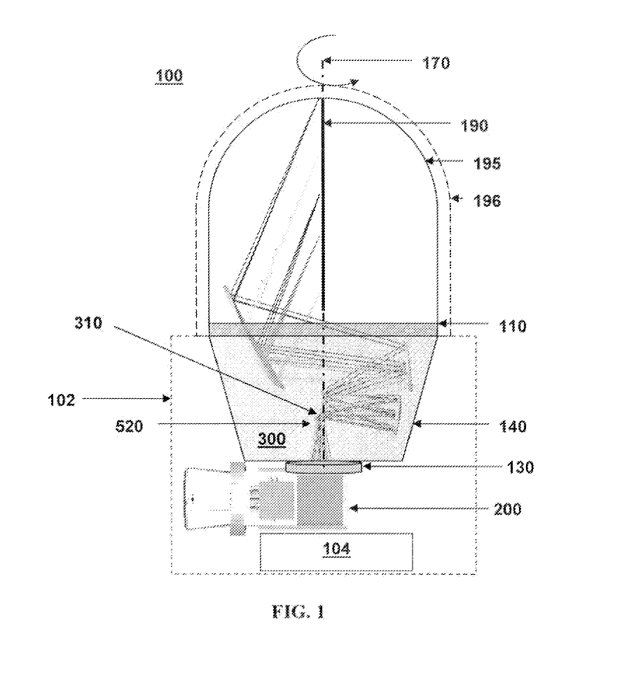

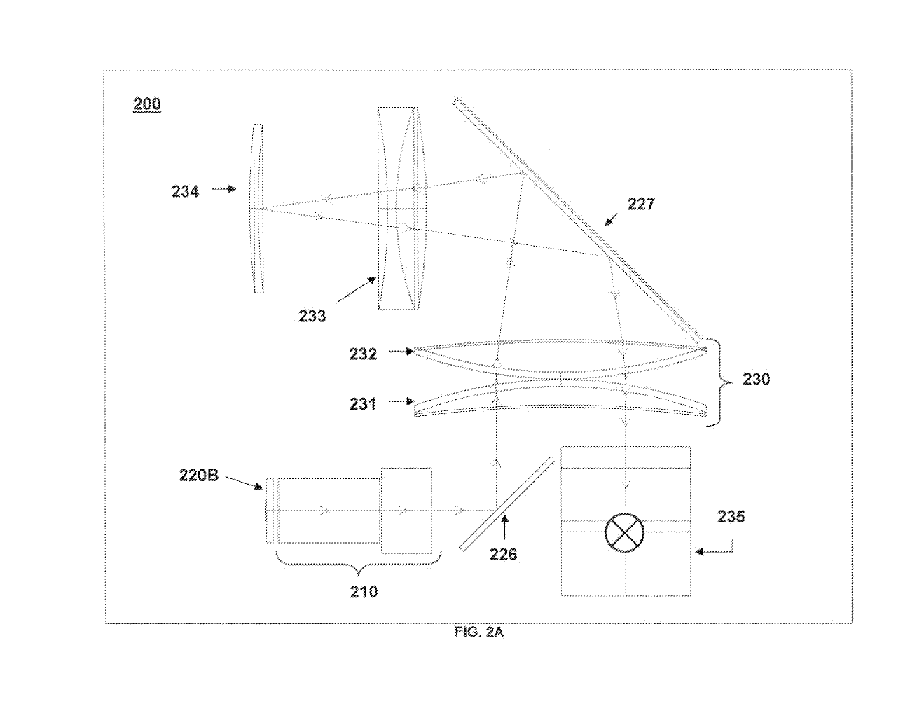

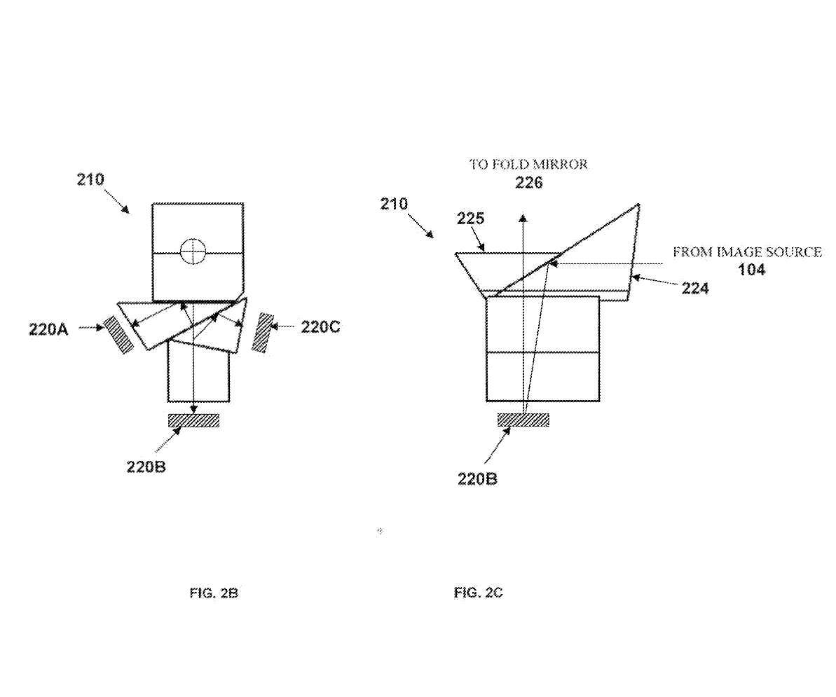

FIG. 1 shows an embodiment of a volumetric display 100. The volumetric display 100 includes a lower housing 102 that contains a portion of the display 100 not visible to the viewer. Inside the lower housing 102 is an image data and illumination module 104, a front-end optical assembly 200 that includes image formation devices 220A, 220B, and 220C (FIG. 2B) and optical elements to relay a beam representing the formed image, a frameless DC motor 130, and a casing 140 coupled to the motor 130. The casing 140 houses a back-end optical assembly 300 and rotates with the motor 130 during operation. The image data and illumination module 104 can include an electronic interface to provide image data to the image formation devices 220A, 220B, and 220C from a computer or other data source (not shown). Alternatively, the image data and illumination module 104 can receive image data embodied on a computer readable medium (e g., a DVD).

The volumetric display 100 also includes a domed rotating portion from which the viewer perceives the projected three-dimensional image. A projection screen 190 (shown from an edge view) is mounted on and perpendicular to, a circular platform 110 mounted to the top of the casing 140. The casing 140 is concentrically mounted on an annular shaft of the frameless DC motor 130. During operation the motor rotates the shaft, the casing 140, the platform 110, and the projection screen 190 about a rotation axis 170. Light is projected from the back-end optical assembly 300, through an aperture in the platform 110 to the projection screen 190, and through a transparent dome 195 encasing the projection screen 190. The dome 195 fits into a flange that is mounted on the periphery of platform 110. Dome 195 is also rotated during operation. A second transparent dome 196 encases dome 195. The second dome 196 is stationary during operation and provides protection to the viewer from physically contacting the moving parts. The second dome 196 also protects the viewer from any debris caused by catastrophic bearing failure.

Image data provided, for example, by a host computer, is transformed into a three-dimensional image emitted from the volumetric display 100 as follows. The host computer sends image data and commands over an electronic interface to system electronics in the image data and illumination module 104 that drive the image formation devices 220A, 220B, and 220C. The system electronics processes this information into voxel data and stores the processed voxel data in graphics memory until it is needed for display. When a particular subset of the voxel data is needed (e.g., to project a slice of the three dimensional image), the system electronics sends the voxel data for each of three component colors (e.g., red, green, and blue) to respective spatial light modulators in the front-end optical assembly 200. A light source and homogenizing and collimating optics (not shown) in the image data and illumination module 104 deliver a broadband light beam to the front-end optical assembly 200. The front-end optical assembly 200 separates three color components of the light beam (e.g., red, green, blue (RGB)), spatially modulates the respective component light beams to form three component images, and recombines the three component images to generate a beam carrying a multi-color image. The front-end optical assembly 200 directs the beam using a series of lenses and mirrors that focus the beam to form an intermediate image at an intermediate image plane 520 centered on and perpendicular to the rotation axis 170. The back-end optical assembly 300 includes a “periscope” mirror 310 that directs the beam to a series of curved mirrors that relay and magnify the intermediate image to the projection screen 190. The back-end optical assembly 300 forms a two-dimensional magnified image on the screen 190 while reducing image distortion (e.g., keystone distortion).

The motor 130 rotates the casing 140, back-end optical assembly 300, and projection screen 190 at a frequency greater than the critical flicker fusion frequency. This condition meets the requirements for the persistence of the human visual acuity system to integrate the rapid angularly deviated succession of 2-dimensional images into a perceptively seamless 3-dimensional volume-filling image (e.g., in some embodiments the rotation is about 1400 rpm or more). The motor 130 rotates all of these components at the same angular velocity. The light weight and compact size of the mirrors in the back-end optical assembly 300 enables the volumetric display 100 to remain stable under the centrifugal forces generated at this velocity.

The centrifugal forces generated during operation are sufficient to deform the mirrors' surface profiles (e.g. surface curvature, power, and irregularity). One method of compensating for the mirror deformation is the use of pre-deformed mirrors that assume their nominal design properties at the nominal rotational velocity. In this exemplary implementation, manufacturing processes and materials are chosen such that mirror deformation is less than or equal to 0.10 wavelengths (for a 632.8 nm reference wavelength), obviating the need for pre-deformed mirrors. Such manufacturing processes include 5-axis diamond turning for shaping, light-weight substrates (e.g. aluminum, silicon carbide, beryllium, beryllium-aluminum alloy, etc.), and post-polishing and coating (e.g. protected silver or nickel plating).

System electronics driving the image formation devices 220A, 220B, and 220C in the front-end optical assembly 200 cooperatively refreshing the projected two-dimensional image at a frame rate synchronized with the rotational velocity of the back-end optical assembly 300 (e.g., in some embodiments about 16,400 frames per second per color). Each two-dimensional image forms an “image slice” of the three-dimensional volume image. As stated above, at these projection and rotation rates the human visual system perceptually fuses the “image slices” into a volume-filling, three-dimensional image.

The projection system is designed to be highly compact so as to fit within a very limited space within casing 140 and dome 195, while at the same time providing the desired image magnification (e.g., in the range of 20× to 30×). The two-part projection system including the front-end optical assembly 200 and the back-end optical assembly 300 is additionally designed to relay the light beam from a stationary source to a rotating screen. An exemplary implementation of such an optical projection system is described in more detail below.

Referring to FIGS. 2A, 2B and FIG. 2C, the front-end optical assembly 200 includes a prism assembly 210 which receives the broadband light beam from the image data and illumination module 104 (at surface 224), splits the broadband light beam into three primary color components (i.e., red, green, and blue), and directs each component to a respective image formation device 220A, 220B and 220C, such as a spatial light modulator (SLM), (only one of which is shown in FIGS. 2A and 2C). The image formation devices 220A-220C can be, for example, any of a variety of micro-electromehcanical systems (MEMS) including arrays of switchable micromirrors, capable of producing high-resolution (e.g., XGA-resolution of 1024×768) imagery at a frequency of 16 kHz or higher. An exemplary SLM is a Digital Micromirror Device (DMD), a semiconductor-based array of thousands of individually addressable, tiltable, mirror-pixels based on DLPTM Technology. Each SLM spatially modulates its respective incident light beam to generate a red, green, or blue component image according to the image data from the image data and illumination module 104. These reflected component images are recombined inside prism assembly 210 to create a native 3-bit color image that exits the prism assembly 210 at a surface 225 of the prism assembly 210. Any of a variety of techniques, including pulse width modulation, spatial dithering, and temporal dithering can be used to achieve bit depths of 8-bits or higher and color pallets consisting of millions of colors. In addition, the recombination of the three color component images (the RGB component images) can be controlled by system electronics and software to produce a native 1-bit grey-scale image (producing black and white). The same techniques stated above can be used to produce 8-bit (or higher) grey-scale imagery.

The front-end optical assembly 200 also includes two singlet lenses 231 and 232 that comprise telecentrizing field lens system 230, a negative doublet lens 233, a spherical mirror 234, two fold mirrors 226 and 227, and a 90 degree prism 235. The first fold mirror 226 directs the light beam emerging from the prism assembly 210 to the telecentrizing field lens system 230. The lens system 230 directs the light beam to the second fold mirror 227, whose angle of incidence is adjustable. The second fold mirror 227 directs the light beam to the “achromatizing” negative doublet lens 233 which is configured to reduce chromatic aberration in the beam. After a first pass through the doublet lens 233 the light beam reflects from the spherical mirror 234 and makes a second (reverse) pass through the doublet lens 233. The spherical mirror 234 is adjustable along the z-axis (for focus adjustment) and tilts about the x and y axes (for pointing adjustment). The reverse path of the beam from the spherical mirror 234 through the doublet lens 233, the fold mirror 227, the telecentrizing field lens system 230, and the 90 degree prism 235 is symmetrical with the forward path from each of the SLMs to the spherical mirror 234. This symmetry, in conjunction with the radius of curvature of the retro-reflecting spherical mirror 234 nulls spherical aberration to produce an intermediate image at plane 520 whose spherical aberration is nearly zero. The 90 degree prism 235 steers the beam path above the front-end optical assembly 200 to the back-end optical assembly 300 along the rotation axis 170.

The front-end optical assembly 200 images the component images generated at the “object planes” of the respective image formation devices 220A-220C (e.g., image formation device 220B) to an intermediate image at the intermediate image plane 520 about 10 millimeters below the periscope mirror 310 of the back-end optical assembly 300. The intermediate image has approximately a unity magnification with respect to the object planes (e.g., the active regions of SLMs used as image formation devices 220A-220C) and is formed in the plane 520, perpendicular to and centered on the rotation axis 170.

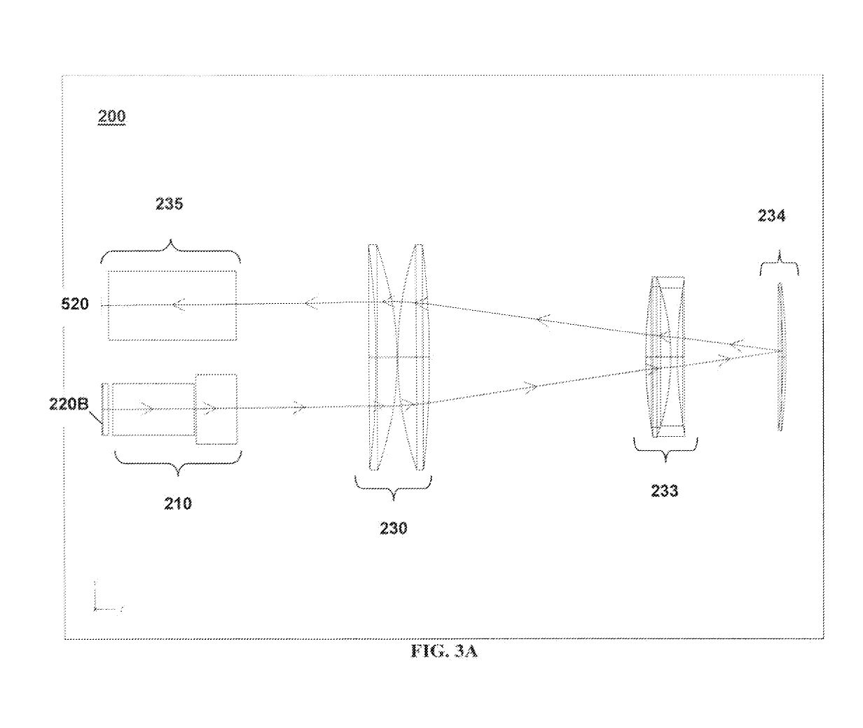

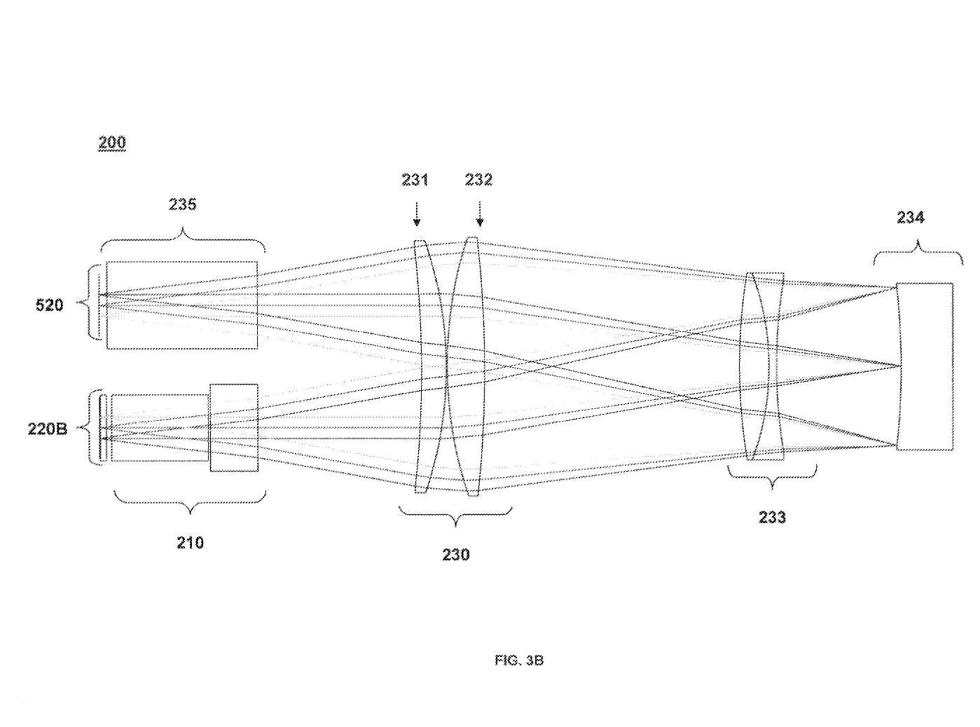

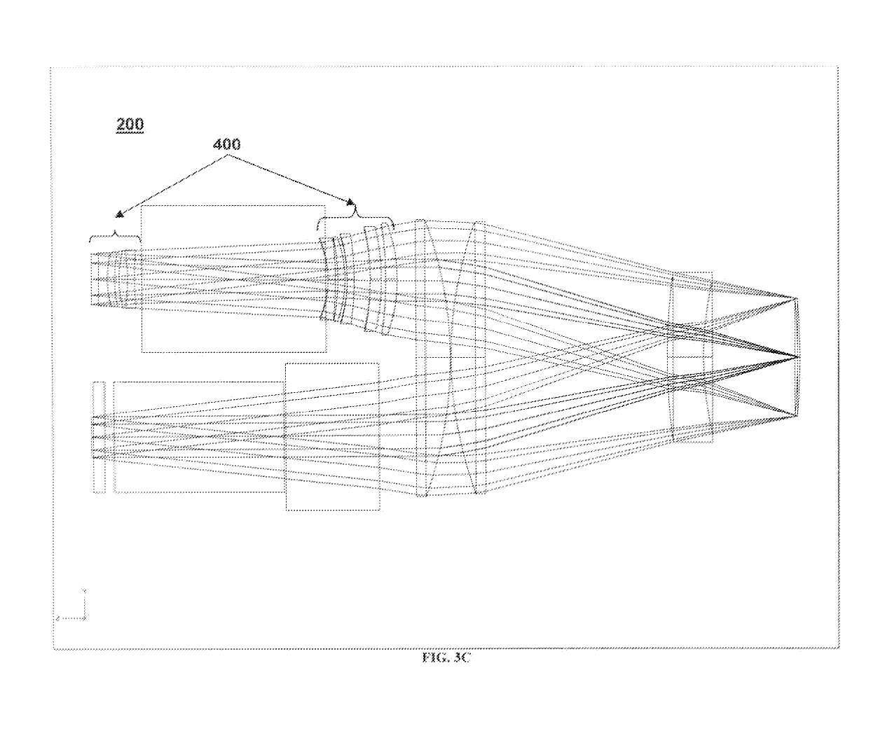

FIGS. 3A and 3B show geometric optics ray tracing of unfolded forward and reverse paths through the front-end optical assembly 200. FIG. 3A shows a forward and reverse path for a chief ray, and FIG. 3B shows the marginal rays for three points in the object and intermediate image planes. The telecentrizing field lens system 230 provides telecentric light beams to the negative doublet lens 233 that corrects the negative axial chromatic aberration induced by the prism assembly 210 and the field lens system 230 such that any residual chromatic aberration, as measure in the transverse beam profile, is less than 1 pixel in width in the intermediate image. The spherical mirror 234 is configured such that, at a nominal focus position, the image formation plane and the intermediate image plane 520 (from the point of view of the unfolded paths) are in the plane defined by the center of curvature of the spherical mirror 234. Since the object and image lie at the center of curvature of the spherical mirror, spherical aberration contribution from this surface is approximately zero (e.g., less than a wavelength) to all orders. Based on the symmetry of the system about the aperture of the spherical mirror 234, the odd order aberrations (e.g., coma, distortion, and lateral color) are approximately zero.

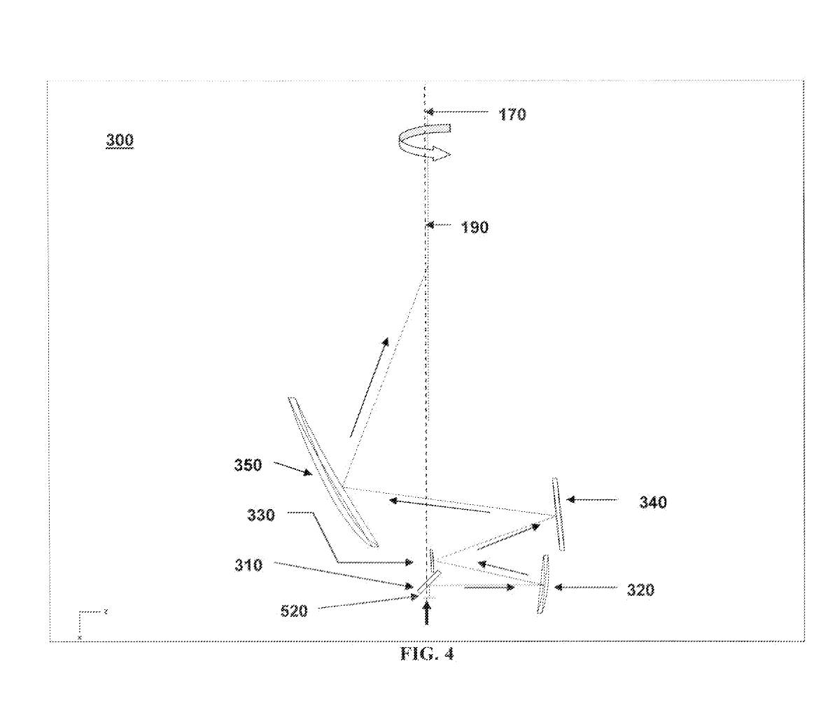

For example, the forward path of the beam through the front-end optical assembly 200 up to the spherical mirror 234 induces more than 40 wavelengths of spherical aberration, coma, astigmatism, and field curvature. Upon completion of the reverse path through the front-end optical assembly 200 (e.g., at intermediate image plane 510) spherical aberration has been compensated for to approximately 0.5 wavelengths. Residual aberrations other than spherical aberration such as astigmatism, coma, field curvature, and axial color, can be corrected using, for example, lens bendings, glass choice, and lens layout. For example, in one embodiment, there is less than 0.1 wavelengths of coma, about 0.5 wavelengths of astigmatism, and about 1.5 wavelengths of field curvature. Some aberration compensation can also be performed by components in the back-end optical assembly 300. For example, in one embodiment, a mirror 330 (FIG. 4) in the back-end optical assembly 300 compensates for field curvature.

The front-end optical assembly 200 images each component image generated at an image formation device object plane over an optical path to an intermediate image. This intermediate imaging helps to keep the total optical path length and image magnification within the constraints provided by a compact display housing 102 and dome 195 (e.g., 12.5 inches in diameter). Imaging the image formation device component images directly to the back-end optical assembly 300 from the output of the prism assembly 210 would result in a longer total optical path length than in a system with the front-end optical assembly 200 due to the effects of propagation through the glass of the prism assembly 210. Imaging the image formation device component images to the back-end optical assembly 300 from an intermediate image with a magnification of unity allows the optical components of the back-end optical assembly 300 to be placed close to the intermediate image, and a much shorter total optical path length can be achieved for a given F-number.

The fold mirrors, 226 and 227 fold the forward and reverse light paths to maintain them within the space available for the front-end optical assembly 200. Fold mirror 227 also tilts in “alpha” and “beta” about two orthogonal fulcrum points at the side and bottom edges of the mirror 227 to provide beam steering for alignment.

The 90 degree prism 235 directs the light beam above the front-end optical assembly 200 along the rotation axis 170 through an annular shaft (not shown) of the frameless DC motor 130 to the back-end optical assembly 300. A prism is used to fold the beam path from the front-end optical assembly 200 rather than a simple mirror in order to provide further color balancing. The compensation and folding prism 235 is designed to have substantially the same index, optical path length, and effective dispersion as the trichroic prism assembly 210. This condition, in conjunction with symmetric object and image space F-numbers and the choice of lens glass types used, allow axial chromatic aberration to be reduced to less than the width of 1 pixel. Rotation axis 170 is coincident with the propagation axis of the beam that exits the prism 235. The fold mirror 227 and the spherical mirror 234 are manually adjustable during final alignment, enabling accurate centration and focus of the image on the projection screen 190. Referring to FIG. 3C, in some implementations of the frond-end optical assembly 200, anamorphic optical elements 400 can be placed into the beam path to convert the image formation devices' available aspect ratios to the 1:1 aspect ratio used by the back-end optical assembly 300. In the depicted embodiment (FIG. 3C), the anamorphic optical elements 400 include transmissive anamorphic elements (e.g., cylindrical lenses). In other embodiments, any anamorphic beam shaping optics can be used (e.g., prism, reflective, diffractive, holographic, etc.).

Referring to FIG. 4, the back-end optical assembly 300 includes a periscope mirror 310 that directs the light beam to a series of optical elements that manipulate the wavefront of the beam (e.g., the divergence and transverse profile of the beam). In this exemplary implementation, the assembly 300 includes four curved mirrors 320, 330, 340, and 350 that together magnify and project the image formed by the image formation devices 220A-220C onto the projection screen 190, and compensate for a majority of distortions that result from projection at non-normal angles of incidence.

For example, keystone distortion corresponds to an uncollimated beam (i.e., a beam made up of non-parallel rays) intersecting the projection screen at a non-normal angle of incidence causing a square to appear as a trapezoid. Pincushion distortion corresponds to beam characteristics for which magnification increases with increasing distance from the propagation axis causing lines that do not go through the center of the image to bow inwards towards the center of the image. Barrel distortion corresponds to beam characteristics for which magnification decreases with increasing distance from the propagation axis causing lines that do not go through the center of the image to bow outwards towards the edge of the image.

In one embodiment, the area of the screen 190 onto which the image is projected spans a diameter of about 10 inches, corresponding to about 24× magnification of the image from the intermediate image plane 520 to the screen 190. In other embodiments, larger display screen sizes and magnifications are achievable. As mentioned above, during operation, motor 130 rotates the back-end optical assembly 300 about the rotation axis 170. The F-number that characterizes the projection system is established to be slow at the projection screen 190, so there is a large depth of focus. The image also has low astigmatism and minimal lateral color. Residual distortion at the final image is less than 5% for all points in the projected field. The image quality at the projection screen 190 is sufficient to resolve the Nyquist frequency of the DMDs used as image formation devices, at the magnification used, with an average modulation transfer function (MTF) that is less than 30% below the diffraction limit for all field locations and wavelengths. This resolution is equivalent to about 3 pixels per millimeter at the projection screen 190 for the embodiment with a 10-inch screen 190 and a 24× magnification.

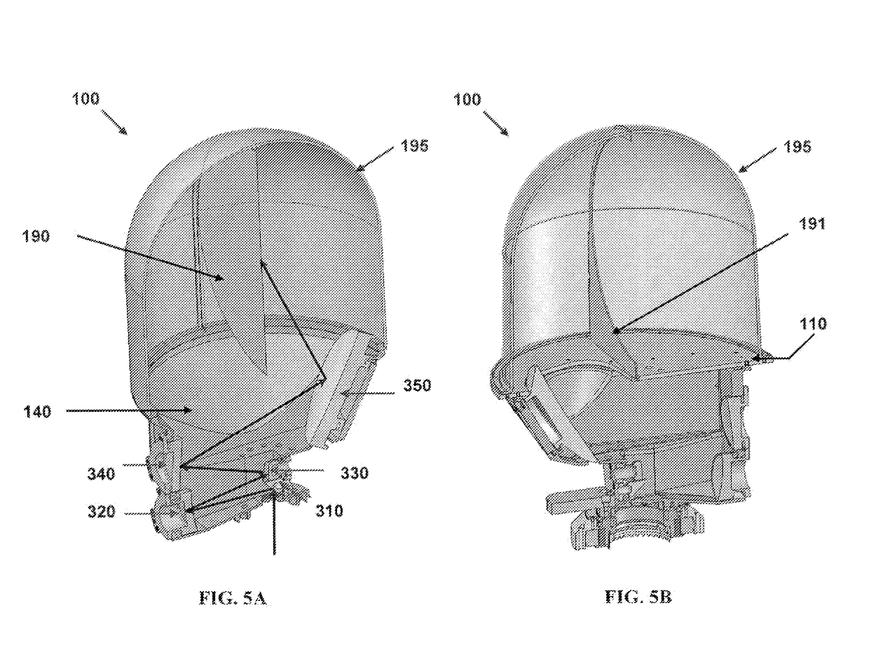

FIGS. 5A and 5B show cut-away perspective views of a top portion of the volumetric display 100 showing how the mirrors 310, 320, 330, 340, and 350 of the back-end optical assembly 300 are mounted in casing 140. FIG. 5A shows the path of the light beam (or the chief ray of the light beam) reflecting from each of the mirrors to the projection screen 190. FIG. 5B shows a frame 191 mounted to the platform 110 and dome 195 which secure the projection screen 190 in place. In another embodiment, the screen can be housed by a rigid structure that secures to the platform 110 and whose top center point is mechanically controlled by a bearing located in the stationary dome 196. In such an embodiment, a balanced system can be achieved without the use of the rotating dome 195.

The mirrors 320, 330, 340, and 350 are off-axis aspheric front surface reflectors. The periscope mirror 310 functions to steer the beam path to the mirror 320, and by virtue of its location on the rotation axis 170, maintains this function during operation. Mirror 320 is a concave mirror that provides the functional equivalent of a field lens in a refractive system. Mirror 330 is convex and functions to help correct the Petzval sum (which characterizes the curvature of the image wavefront), thus enabling the image to be projected at non-normal incidence onto a “flat field” or planar surface without distortion. Mirror 340 is concave and provides a large measure of compensatory aberration correction to the image. Mirror 350 is substantially anamorphic. In one embodiment, the mirror 350 has a reflective surface with negative curvature (or “Gaussian curvature”) such that the curvature along a first cross-section is convex and the curvature along the orthogonal cross-section is concave (e.g., shaped as a saddle) and functions to form a focused image on the projection screen 190 (e.g., the focal plane is tilted according to the angle at which the image is projected onto the projection screen 190). Also, mirror 350 provides most of the compensation for non-linear distortions due to projection at non-normal angles of incidence (e.g., pincushion and barrel distortion).

Software in the image data and illumination module 104 processes the stored voxel data to reduce residual distortion not corrected by the back-end optical assembly 300 to bring the total distortion to no more than 1 pixel width at any point across the field. However, this software distortion compensation results in fewer of the available pixels of the image formation device (e.g., a DMD) being utilized for image formation. By providing a majority of the distortion compensation optically with the back-end optical assembly 300, most of the pixels of the image formation device can be utilized for image formation. The software also corrects for “image tumbling” (i.e., image rotation in the projection screen plane) by counter-rotating the voxel data provided to each image formation device. Without this correction, image tumbling would occur because the front-end optical assembly 200 present a fixed image relative to the rotating periscope mirror 310.

The projection screen 190, which is centered on the rotation axis 170, is typically formed from a diffusely scattering material. This material scatters incident light substantially isotropically, both in a forward and backward direction. This ensures that a portion of the light corresponding to a pixel in a two-dimensional image slice will be received by a viewer standing in almost any viewing locale around the display, minimizing the dark bands in the three-dimensional image known as “visual dead zones.” Designing the projection screen and host to be as thin as possible can also minimize the visual dead zones. In addition, the forward and backward scattering screen 190 enables a full volume rendering over a ½ rotation, thus doubling the refresh rate and halving the necessary rotational velocity of the system.

A number of embodiments of the invention have been described. Nevertheless, it will be understood that various modifications may be made without departing from the spirit and scope of the invention. For example, in the illustrated embodiment, the projection screen 190 is circular in shape. In general, the projection screen 190 can have any size and shape sufficient to receive the projected image, as long as the image is positioned with minimal offset and eccentricity with respect to the rotation axis 170.

Also, platform 110 and casing 140 are not limited to the circular platform and casing described above. In general, the platform and casing 140 may be any supporting structure, or combination of supporting structures, sufficient to mechanically couple the back-end optical assembly 300 and projection screen 190 to the motor 130. In general, the motor 130 can be any motor which rotates the casing 140 at the desired rate. In some embodiments, for example, the platform 110 is coupled to the motor 130 by belts and/or gears, and the motor 130 is positioned away from the rotation axis 170.

In some embodiments, an emissive pixelated device can replace the image formation devices 220A-220C and portions of the image data and illumination module 104. Examples of such devices include arrays of light emitting diodes, including organic light emitting diodes, or vertical cavity surface-emitting lasers (VCSELs). The optical and electro-optical components used to form, illuminate, and relay the image to the projection screen 190 are not limited to those described above. Any combination of lenses, mirrors, diffractive and holographic optical elements, or other light-controlling or light-generating component may be used for this purpose.

Accordingly, other embodiments are within the scope of the following claims.

What is claimed is:

1. A system comprising:
a first optical assembly configured to provide a light beam representing an image, the first optical assembly being disposed on a first support structure;
a motor coupled to the first support structure and configured to rotate a second support structure, relative to the first support structure, about a rotation axis; and
a second optical assembly that includes one or more optical elements configured to manipulate the light beam to reduce distortion in the image caused by projection of the light beam onto a projection screen at a non-normal angle of incidence, the second optical assembly being disposed on the second support structure.

2. The system of claim 1, further comprising an image data and illumination module configured to provide an unmodulated light beam and image data defining the image, wherein the first optical assembly is configured to generate the light beam by spatially modulating the unmodulated light beam according to the image data.

3. The system of claim 1, further comprising a projection screen disposed on the second support structure and positioned to receive a manipulated light beam from the second optical assembly, the projection screen having a substantially flat surface that is substantially parallel to the rotation axis.

4. The system of claim 2, wherein the second optical assembly includes a mirror disposed along the rotation axis to receive the light beam from the second optical assembly.

5. The system of claim 4, wherein the first optical assembly is configured to image the spatially modulated light beam to an intermediate image plane, where the intermediate image plane is substantially perpendicular to the rotation axis and less than about two centimeters from the mirror.

6. The system of claim 2, wherein the first optical assembly is further configured to:
split the unmodulated light beam received from the image data and illumination module into a plurality of component beams of different color;
modulate each component beam according to corresponding image data; and
recombine the modulated component beams into in a combined light beam representing a multi-color image.

7. The system of claim 6, wherein the first optical assembly includes a plurality of optical elements arranged to support forward light paths from locations at which the component beams are modulated to a mirror and reverse light paths from the mirror to an output of the first optical assembly, where the forward light paths are arranged with respect to the reverse light paths to enable the reverse path to at least partially compensate for aberrations produced by the forward path.

8. The system of claim 7, wherein the reverse path is arranged to substantially compensate for spherical aberration produced by the forward path.

9. The system of claim 8, wherein the reverse path is arranged to reduce spherical aberration produced by the forward path to less than one wavelength.

10. The system of claim 6, wherein the first optical assembly includes at least one optical element configured to reduce chromatic aberration induced by other optical elements of the first optical assembly.

11. The system of claim 1, wherein the second optical assembly is configured to manipulate the light beam to reduce one or more of keystone distortion, pincushion distortion, and barrel distortion.

12. The system of claim 1, wherein the second optical assembly is configured to manipulate the light beam to compress the transverse profile of the light beam along a first transverse direction relative to a second perpendicular transverse direction.

13. The system of claim 12, wherein the amount of relative compression is based on an angle at which the image is to be projected onto the projection screen.

14. The system of claim 1, wherein the second optical assembly is configured to provide a tilted focal plane according to the angle at which the image is projected onto the projection screen.

15. The system of claim 1, wherein the second optical assembly is configured to manipulate the light beam to provide a large depth of focus at the projection screen.

16. The system of claim 15, wherein the depth of focus is larger than the size of the projected image multiplied by the sine of the angle of incidence at the projection screen.

17. The system of claim 1, wherein the second optical assembly is further configured to manipulate the light beam to substantially flatten the field of the image represented by the light beam.

18. The system of claim 1, wherein the second optical assembly consists essentially of reflective optical elements including at least one curved mirror.

19. The system of claim 18, wherein the second optical assembly includes at least one mirror having a negative curvature characterized by a concave curvature along a first cross-section and a convex curvature along an orthogonal cross-section.

20. The system of claim 19, wherein the second optical assembly includes one mirror having a negative curvature, at least one mirror having a positive convex curvature, and at least one mirror having a positive concave curvature.

21. The system of claim 2, wherein the second optical assembly is configured to magnify the image when projected onto a projection screen, relative to the size of the image when spatially modulated onto the light beam by the first optical assembly.

22. The system of claim 21, wherein the magnification is at least a factor of 10.

23. The system of claim 2, wherein the image data and illumination module is configured to process the image data to reduce residual distortion not corrected by the one or more optical elements of the second optical assembly.

24. The system of claim 1, wherein the second optical assembly is configured to reduce distortion in the image such that the size of any residual distortion is less than about 5% of the size of the image.

25. The system of claim 1, wherein the second optical assembly is configured to reduce distortion in the image such that any point in the projected image is displaced from its respective location in the image provided by the first optical assembly to less than 5% relative to the size of the projected image.

26. The system of claim 2, wherein the image data and illumination module is configured to process the image data to reduce distortion in the image such that the size of any residual distortion not corrected by the combined effect of the processing and the one or more optical elements of the second optical assembly is less than 2% of the size of the image.

27. The system of claim 2, wherein the image data and illumination module is configured to process the image data to reduce distortion in the image such that the size of any residual distortion not corrected by the combined effect of the processing and the one or more optical elements of the second optical assembly is less than the size of two pixels of the image.

28. The system of claim 1, wherein the first optical assembly and the second optical assembly include one or more adjustable components to project the image onto the projection screen in-focus and approximately centered on the projection screen.

29. A method, comprising:
providing a light beam representing an image from a stationary source;
rotating a projection screen, relative to the stationary source, about a rotation axis;
projecting the light beam onto the projection screen at a non-normal angle of incidence; and
manipulating the light beam to reduce distortion in the image caused by projection of the light beam onto the projection screen.

30. The method of claim 29, further comprising providing an unmodulated light beam and image data defining the image, wherein the light beam representing the image is generated by spatially modulating the unmodulated light beam according to the image data.
